(19) United States
(12) Patent Application Publication
(10) Pub. No.: US 2014/0351014 A1
(43) Pub. Date: Nov. 27, 2014

(54) PROPERTY VALUATION INCLUDING ENERGY USAGE

(71) Applicant: EQS, Inc., Austin, TX (US)

(72) Inventor: Teresa Lopez, Austin, TX (US)

(73) Assignee: EQS, Inc., Austin, TX (US)

(21) Appl. No.: 14/285,537

(22) Filed: May 22, 2014

Related U.S. Application Data
(60) Provisional application No. 61/826,108, filed on May 22, 2013.

(51) Int. Cl. G06Q 30/02

(52) U.S. Cl. CPC G06Q 30/0202
USPC 705/7.31

(57) ABSTRACT

An apparatus, system, and method for property valuation including energy usage. A method is disclosed that includes predicting energy usage for a property for a period of time, aggregating a predicted energy usage reduction based on a project that decreases the energy usage for the property, and determining a value adjusted for the aggregated energy usage reduction. An apparatus or system perform the method.

### CROSS-REFERENCES TO RELATED APPLICATIONS

This application claims the benefit of, U.S. Provisional Patent Application No. 61/826,108 entitled “INTEGRATING A UTILITY BASELINE FOR PROPERTY VALUATION” and filed on May 22, 2013 for Teresa Lopez, which is incorporated herein by reference.

### BACKGROUND

1. Field

This invention relates to property valuation and more particularly relates to property valuation including energy usage.

2. Description of the Related Art

Property owners concerned about the environment or who wish to save money may wish to reduce the consumption of utilities, and in particular to reduce the consumption of nonrenewable energy. Generally, modifications to a building may make the building consume less energy over a period of time.

Modifying an existing building may include improved or increased insulation, installing photovoltaic cells or wind generators, rainwater harvesting, geothermal systems, or the like. Technologically, installing energy-efficient or green energy systems in homes and offices is achievable. However, financial entities, appraisal entities, or similar typically do not include an energy efficiency method of a property in determining a quantified approximate value for the property. Therefore, a property owner who may wish to enhance the energy efficiency of the property may not receive the value of the enhancements upon sale of the property. Therefore, there is less incentive for a property owner to perform energy efficient modifications to a building or structure.

Also, because the energy efficiency of a property is not typically included in a property valuation, a property owner may not be able to get financing for an energy reduction project. Some projects that may increase the energy efficiency of a property may require significant financial investment. Leaving the financial burden for an energy reduction project to a property owner may make it more difficult for a property owner perform more significant or substantial energy efficiency projects.

### SUMMARY

From the foregoing discussion, it should be apparent that a need exists for an apparatus, system, and method that recognizes the value of energy efficiency for a home or business property involved in a financial transaction. Beneficially, such an apparatus, system, and method would help to quantify or provide a valuation of a utility costs that is realized through incorporation of energy-efficient or energy producing systems. Another advantage made possible by such an apparatus, system, and method is the automatic application of a clearly quantified utility savings to one or more financial transactions that have a monetary value corresponding to the quantified savings.

The present invention has been developed in response to the present state of the art, and in particular, in response to the problems and needs in the art that have not yet been fully solved by currently available incentive programs, financing programs, and investment programs. Accordingly, the present invention has been developed to provide an apparatus, system, and method for determining energy savings and/or incentive credit(s) and applying those savings and/or credit(s) to a financial transaction in ways that are outside the realm of conventional incentive, financing, and investment programs. The apparatus, system, and method overcome some or all of the above-discussed shortcomings in the art.

Furthermore, an apparatus, system, and method for determining and applying a utility savings and/or incentive credit(s) to a financial transaction may include applying a portion of the utility savings and/or credit(s) to at least one of early repayment of a mortgage loan and investment in securities.

The method may further include predicting energy usage for a property for a period of time, aggregating a predicted energy usage savings based on a project that decreases the energy usage for the property, and determining a value adjusted for the aggregated energy usage savings. A system and apparatus perform the method.

### BRIEF DESCRIPTION OF THE DRAWINGS

In order that the advantages of the invention will be readily understood, a more particular description of the invention briefly described above is set forth by reference to specific example embodiments that are illustrated in the appended drawings. These drawings depict only typical embodiments of the invention and are not to be considered limiting of the scope. Thus, embodiments of the invention will be described and explained with additional specificity and detail through the use of the accompanying drawings, in which:

FIG. 1 is a block diagram of a system and apparatus for integrating a utility baseline for property valuation and applying at least a portion of the savings to a financial transaction in accordance with embodiments of the present disclosure;

FIG. 2 is a another block diagram of one embodiment of a system and apparatus for integrating a utility baseline for property valuation and applying at least a portion of the savings to a financial transaction corresponding to a portion of the block diagram of FIG. 1 in accordance with embodiments of the present disclosure;

FIG. 3 is a block diagram illustrating a method for integrating a utility baseline for property valuation in accordance with embodiments of the present disclosure;

FIG. 4 is a diagrammatic representation of the extensive usefulness of a system for integrating a utility baseline for property valuation in accordance with embodiments of the present disclosure;

FIG. 5 is a graph showing quantified energy reduction values in accordance with embodiments of the system and methods of the present disclosure;

FIG. 6 is a block diagram showing specifics of one aspect of the system and apparatus for integrating a utility baseline for property valuation in accordance with embodiments of the present invention;

FIG. 7 is a block diagram illustrating a system for integrating a utility baseline for property valuation in accordance with embodiments of the present invention;

FIG. 8 is a flow chart diagram illustrating one example of a method in accordance with one embodiment of the present invention;

FIG. 9 is a diagram illustrating one example of a method for property valuation including energy usage;

FIG. 10 is a flow chart diagram illustrating one embodiment of a method for property valuation including energy usage;

FIG. 11 is an example chart depicting one example according an embodiment of the present invention;

FIG. 12 is a diagram illustrating one embodiment of an apparatus in accordance with the present invention;

FIG. 13 is a flow chart diagram illustrating one embodiment of a method in accordance with one embodiment of the present invention; and

FIG. 14 is a flow chart diagram illustrating one embodiment of a method in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. However, the invention may be practiced without one or more of the specific details, or with other methods, components, materials, and so forth. In other instances, well-known structures, materials, or operations are not shown or described in detail to avoid obscuring aspects of the invention.

The disclosed systems, methods and apparatuses may include various uses of energy. As described herein, energy may include natural gas, propane, water, electricity, fuels, solid fuels, solar power, liquid fuels, gas fuels, alternative fuels, biomass, geothermal, hydro power, wind energy, agricultural products, or other forms of energy described herein, or the like.

In one embodiment, a method is described for financing an energy reduction measure. As described herein, “financing” may include determining an approximate future value that may justify an initial financial investment and financing may include providing the initial financial investment in the energy reduction measure. Financing may include present or future value, discounted value, rate-determined value by an appraiser, depreciation values, may use established indices and amortization and/or life cycle of equipment, or other, or the like as one skilled in the art may appreciate.

In one example, an energy reduction measure may indicate future profits or benefits that may be used to repay the initial financial investment. In another example, energy transportation costs associated with an electric vehicle may be applied to a loan balance. Net energy or transportation cost savings or reductions may be applied to the loan balance.

An energy reduction measure, as used herein may include, but is not limited to, any of the following, any combination of the following, or any portion of the following: traditional fuels, alternative fuels, biomass, geothermal, hydro power, water conservation, wave tidal power, renewable energy, solar energy, coal energy, wood burning, wind energy, production of agriculture, green roof, living roof, insulation, structural alterations, energy efficient appliances, energy efficient lighting, electric vehicle energy generation, irrigation systems, or the like. An energy reduction measure may include installation of one or more systems or devices to reduce consumption of energy. Consumption of energy may include a measured consumption of a municipal utility, such as, but not limited to, water, natural gas, propane, electricity, carbon reduction, or the like. An energy reduction measure may also include making structural alterations to a structure in order to reduce the consumption of energy of the structure. Therefore, an energy reduction measure may include modifications of existing systems of structures of a building, or removing items. For example, an energy reduction measure may include affecting air flow through or in a structure. Removing structure, walls, windows, or the like may also reduce the consumption of energy for a property. An energy reduction measure for a property may also include installing, modifying, or removing structure from the property.

In one embodiment, a determination module may include a utility baseline. A utility baseline may include a predicted use of energy for a property. The baseline may include an energy allowance, basic energy needs and may be updated at regular intervals depending on trends in usage of energy, changes in market prices for energy, or the like. A baseline may include altitude, temperature, climate zones, humidity, weather patterns, seasons, service territories, or the like. A baseline may be determined as a percentage of an average residential consumption of energy within a baseline zone. A baseline may include the age of a property, square footage, other physical features, amenities, Zero-landscaping, xero-gardening, Xeriscaping, energy efficient features and reductions, other energy or costs reductions, or the like. For example, older structures may be less energy efficient than newer structures. A baseline may also be modified based on a number of occupants for a property, or special medical needs of occupants of a property. A baseline may also consider variations in municipal utility rates. For example, a utility company may partition rates depending on energy consumption for residents of a baseline zone. A baseline may consider these variations and other, or the like. A baseline may be determined based on any number of algorithms, equations, or combinations of equations, values, numbers, or the like, and may be aggregated regionally. A baseline may also be reported individually, based on any of the aforementioned considerations, or others, or the like.

After reading this disclosure, it may become apparent to one skilled in the art that the fundamental model for measuring and distributing energy may be enhanced. Instead of static energy distribution to residential customers, energy may be generated and transferred across an energy grid. For example, a property that may produce more electricity than it uses, may transfer excess electrical energy to the grid. The transferred energy may become available to other residential customers. A utility organization may compensate a property owner for the provided energy. Therefore, in this example, the property may generate income and may be worth more than a static value of the real property.

In another way, property owners may profit from an energy reduction measure. A property owner may enhance a property with an energy reduction measure. As described in this disclosure, an appraisal process may include energy efficiency calculations such that a property owner may receive a fair market value for the energy reduction measures. In some circumstances, a fair market value for an energy reduction measure, may be more than a cost associated with installing or performing the energy reduction measure. In another example, gasoline savings by utilizing excess energy to power an electric automobile may also be used to compensate financial investors.

In one embodiment, a determination module may determine an energy reduction measure for a property. A determination may be based on available funding, tax credits, rebates, and/or involvement of financial markets.

Depending on a variety of factors including, but not limited to, available resources, market prices of raw materials, available materials, or other, or the like. A cost required to perform an energy reduction measure may vary. In another embodiment, a determination of an energy reduction measure may be based on available funds from any of the following: a property owner, a financial institution, a venture capitalist, an advertiser, a private capital portfolio lender, utility financing program, home equity program, home improvement lender, private investor, a private capital portfolio lender, a utility financing program, a home equity financing program, a home improvement program, or other, or the like. In one example, available funding for an energy reduction measure may not exceed a specific value. Therefore, a determination of an energy reduction measure may be limited to energy reduction measure that may be accomplished using available funding.

In another embodiment, a determination of an energy reduction measure may be based on a preference of a property owners. Regardless of available funding, a property owner may prefer one energy reduction measure over another. In one example, a property owner may prefer an energy reduction measure based on solar energy. A determination to perform a solar powered energy reduction measure may be based on a preference of the property owner. In many examples, a preference of a property owner may include, colors, styles, sizes, or the like, of equipment for an energy reduction measure. A preference of a property owner may also be based on current trends, styles, artistic perception, to be developed technology, new technology, or the like. In one example, excess energy may be used to power an electric automobile and costs associated with a gas powered automobile may be recuperated.

In one embodiment, a determination of an energy reduction measure may be based on a historical analysis. A determination may be based on specific energy reduction measure that has been historically successful. A historical analysis may include data for previous energy reduction measures for an area that includes, or is nearby a property under consideration. A historical analysis may include similar properties in a given geographical area. A historical analysis may include energy reduction measure for similar structures on a property. A historical analysis may include similarities of property owners for properties. In another embodiment, a historical analysis may include habits and behaviors of occupants of a property. A historical analysis may include a number of occupants, behavior of occupants, altering occupant behavior, or the like. A historical analysis may include other considerations that may include any other feature or characteristic that may affect energy consumption of a property as one skilled in the art may appreciate.

In one example, a historical analysis may determine that a property experiences significant winds. Therefore, an energy reduction measure may include wind energy. In another example, a historical analysis may determine that properties in one group experience significant sunlight. Therefore, a determination of an energy reduction measure may include solar energy. In another example, for a given area, a water well may have shown to be particularly effective or efficient. For example, perhaps a well is particularly easy to drill, or is particularly productive in a given area, based on historical analysis. Therefore, a determination of an energy reduction measure may consider an amount of effort required to perform a specific energy reduction measure. Historical analysis may also include rain water harvesting for areas with increase rain water, water conservation systems, water efficiency systems, strike wells, or other, or the like.

In another embodiment, a determination of an energy reduction measure may consider current trends, technological advancements, popularity, or the like. For example, based on a technological advance in lighting that may use less energy than previous lighting technologies, a determination of an energy reduction measure may include a recent technological advancement, and may include currently trending lighting equipment. Similarly, historical popularity may also be a consideration for a determination of an energy reduction measure. For example, specific colors, styles, sizes, available equipment for an energy reduction measure, or the like, may be considered in a determination of an energy reduction measure. Therefore, a determination of an energy reduction measure may include artistic value to a property owner.

In another embodiment, a determination of an energy reduction measure may include preferences of a lending institution, a government utility consumer energy program, or other.

For example, regardless of historical success, historical analysis, preferences of a property owner, or other, or the like, a determination of an energy reduction measure may be based on preferences of a lending institution. For example, in a scenario where a bank may fund an energy reduction measure, preferences of the bank may override other considerations for determination the energy reduction measure. In one example, a lending institution may require additional energy reduction measures, certain technologies, specific contractors, specific energy reduction measures, or the like.

In one embodiment, a determination of an energy reduction measure may include effects of energy consumption of a property. For example, an energy reduction measure that may affect usage of energy more significantly may be preferred over another energy reduction measure that may affect energy usage less significantly. In one example, a property may historically use significant electrical energy that may be supplied using a solar panel. In response, the determination of a specific energy reduction measure may include installing a solar panel, or a solar panel system on the property.

In one embodiment, a method for integrating a utility baseline for property valuation may include an energy audit. An energy audit may include analyzing a property to determine deficiencies in energy usage, or similar. An energy audit may include analyzing a property to determine potential energy reduction measures. In another embodiment, an energy audit may include determining an energy reduction measure as previously described. An energy audit may include a recommendation for an energy reduction measure that may address specific deficiencies or inefficiencies of a property.

In one embodiment, an energy audit may result in a predicted energy performance for a property. In one example, a predicted energy performance of a property may be based on historical data. For example, where similar energy reduction measures had been performed on similar properties, a resulting energy reduction may be considered in predicting an energy performance for a subsequent energy reduction measure. In certain embodiments, similar properties may include, like shaped properties, like shaped structures on the property, properties in a similar geographic location, properties in a like climate, latitude, longitude, elevation, or other, or the like.

In another example, a predicted energy performance of a property may be based on technical analysis. For example, where an energy reduction measure includes integration of energy efficient appliances, an energy use metric from previous appliances may be compared with a predicted energy use metric for new appliances. In this example, a predicted energy reduction may be based on technical information of the appliances. In another example, a predicted energy performance may be based on a repair.

In one embodiment, an energy performance metric for a property may be based on an aggregate utility baseline for a neighborhood. For example, energy use metrics for comparable properties in a neighborhood, or similar geographic area, may be used to predict an energy use metric for a property in the neighborhood. In another embodiment, a database of energy use metrics may be used to predict an energy use for a property. For example, a database of a property listing service, a municipality database, smart meters, or the like, may be used to generate an aggregated utility baseline for a neighborhood. The aggregated utility baseline for the neighborhood may be used to predict an energy performance for a property in the neighborhood.

In another embodiment, an aggregated utility baseline for a neighborhood or geographic region may be calculated based on a survey of property owners or occupants of property located within the region. A survey may include, number of occupants, building thermostat settings, water usage, water usage patterns, lawn care, or other factors that may indicate energy usage or consumption, or the like.

In one embodiment, one or another database may not be available. For example, a property listing service may not provide utility metrics for properties in the listing service. In this example, a municipality database, or smart meters may be used to acquire energy metrics for a neighborhood, or other geographic area, such as, a county, state, country, region, continent, or the like. At other times, the property listing service may provide utility information. Therefore, depending on availability, one or more different databases may be used to aggregate a utility baseline for a geographic area.

In one embodiment, an aggregated utility baseline may include an average count of people, an average structure size, an average age of a property or structure on a property, or the like. An aggregated utility baseline may include any other features, characteristics, properties, or the like, of a property that may affect energy usage or consumption. Other features or factors may include square footage, structure vintage, structure shapes and forms, structure contours, structure air flow capabilities, property problems, weather patterns, climate patterns, average climate, wind zones, rain, snow, humidity, temperature, average maximum temperature, average daily minimum temperature, seasonal patterns, lake effect snow, or other, or the like.

In another embodiment, a utility baseline may also include aggregated carbon reduction calculations, or other aggregated energy efficiency reduction calculations. In one embodiment, a compliance market, a company, a government, or other, may buy carbon reductions in order to comply with caps on carbon dioxide emissions. The emissions caps may be under an international protocol or emission trading scheme. In one embodiment, a property owner may purchase carbon offsets to mitigate their own emissions from other energy sources.

In one embodiment, a calculation module may be configured to calculate a periodic value for the energy reduction measure. In one example, a cost of implementing an energy reduction measure may be divided by an estimated lifetime for equipment associated with the energy reduction measure. For example, a solar panel system may cost $30,000 to install and configure. The lifetime of the solar panel system may be 30 years. A periodic value to cover a cost of the solar panel system over 30 years may be approximately $834 per month. Of course, one skilled in the art may recognize that periodic values may change depending on interest rates, or other market factors. In another example, saved costs may be used to accelerate mortgage repayment or other mortgage reductions.

In another example, the period of a loan to finance an energy reduction measure may be used to determine a periodic value. In one example, multiple energy reduction measures for a property may include upgraded insulation, radiant barriers, smart meters, LED lighting, Geothermal HVAC, Water harvest systems, water conservation technologies and/or measures, low E windows, energy efficient appliances, solar equipment, structured and/or insulated panels, building envelope enhancements, building block systems, or other, or the like. The energy reduction measures may cost $81,800. A property owner may receive rebates, such as, but not limited to, utility rebates, municipality rebates, manufacturer rebates, or the like, of $13,500. A total cost of the multiple energy reduction measures may then be $68,300. In one example, a periodic value over 20 years may be $506. In another example, a periodic value over 30 years may be $448. Periodic values may also depend on loan interest rates, financing costs, bundled loan incentives, private mortgage insurance, home owner's insurance rebates or reductions, or the like.

In one embodiment, the periodic value may be based on a predicted energy usage. For example, a reduction in utility payments associated with the energy reduction measure may be used to offset a calculated periodic payment associated with a loan for one or more energy reduction measures. In another embodiment, the financial transaction may be for the energy reduction measure. In one embodiment, a valuation module may be configured to incorporate the periodic value into a financial transaction. The periodic value may be a present value, a future value, or other value.

For example, a reduction in utility costs associated with an energy reduction measure may be applied to a repayment schedule for a loan. This benefit may be depicted as a reduced interest, or an interest deduction for the loan balance.

In one embodiment, a periodic value may be based on an estimated value of a property after one or more energy reduction measures. In one embodiment, a predicted property value may be based on an energy performance metric. An energy performance metric may be represented by alphabetic characters, or numerical indexes, scales or ranges. In one example, an energy performance rating may be used to indicate an energy performance for a property. For example, a range of indexes, such as E-1, E-2, E-3, E-4, E-5, and E-6 may be used to represent the energy efficiency of a property. In one example, E-1 may indicate a property may generate as much or more energy that it may use. E-1 may indicate that a property has a net zero energy usage, or energy production. E-2 may indicate that a property has been extensively retrofitted to incorporate multiple energy reduction measures. E-3 may indicate that a property has been the target of a few energy reduction measures. E-4 may indicate that a property, or a structure on a property, may have been weatherized. E-5 may indicate that a property has relatively low efficiency. E-6 may indicate that a property has very poor energy performance.

In one embodiment, varying indicators may include specific energy reduction measures. For example, an E-4 rating may include energy control programmable thermostats, air seal building envelopes, thermal bypasses, aligned barriers, air seal weather stripping at windows and doors, seal HVAC ducts, locate ducts in conditioned space, new construction design and location, upgraded insulation, recycle and reduce construction waste, efficient light bulbs, radiant barrier foil, window shading screens and film, and combustion safety. In another example, an E-3 rating may include energy efficient appliances, water conservation shower heads, low flow facets, irrigation, smart meter, whole house energy monitoring, energy efficient light fixtures and ceiling fans, insulation upgrade for walls, floors, etc. In another example, an E-2 rating may include efficient HVAC equipment, energy efficient windows, efficient water on-demand and solar water heater, high performance thermal envelope, whole house insulation, etc. In another example, an E-1 rating may include renewable energy systems, waste heat recovery systems for air and water, supplemental dehumidification and balanced ventilation systems, rain water catchment systems, variable capacity interior driven HVAC and ground source heat pumps, etc. In another example, an E-1+ or E-0 rating may include an electric vehicle, carbon neutral and water neutral systems.

Therefore, in certain embodiments, a single indicator may be used to describe a plurality of energy reduction measures as described herein. In one example, a financial transaction may consider an indicator instead of managing a plurality of energy reduction measures. This may provide increased convenience for financial providers, venture capitalists, owners, private investors, REIT's, pension funds, banks, credit unions, or other investors, or others to ensure their investments are associated with certain energy reduction measures.

In another embodiment, various indicators may have identifiable names associated with the indicators for convenience and familiarity. For example, an E-0 rating may be called “Zero-Net Energy>100%.” In another example, an E-1 rating may be called “Near-Net Zero+Energy Production Between 70% and 100% reduction.” In another example, an E-2 rating may be called “Deep Retrofit.” In another example, an E-3 rating may be called “Light Retrofit.” In another example, an E-4 rating may be called “Weatherize,” “Light Retrofit,” or similar. Of course, this disclosure is not limited in this regard, and other names or identifiers may be used to indicate varying levels of energy performances for a property. Using consistent names for various energy performance metrics may make it more convenient for an industry using these indicators to identify rating levels.

In one embodiment, numerical values may be used to represent or indicate an energy efficiency of a property. For illustrative purposes only, and as an example, a zero may indicate that a property generates at least as much energy as it consumes. A value of 130 may indicate an average existing home. In certain embodiments, an associated value for the property, or period value for a loan, or the like, may be based on the numerical value indicating the energy efficiency of the property. This may allow a simplified interpretation of the energy efficiency of a property without having to analyze specific energy reduction measures, or associated costs.

In one embodiment, conformance with a model code may indicate a property energy performance metric. For example, conformance with model codes such as, international energy conservation codes (IECC), or IRC codes may indicate varying levels of energy efficiency. In another embodiment, other codes may be used. For example, state codes, such as California's Title 24, or other, or the like. In another embodiment, various standards may be used to indicate an energy performance metric for a property. For example, if a property was build consistent with a national association of home builders (NAHB) Green Standard, or a Passivhaus Standard, those standards may indicate an energy performance metric for a property. In one example, a property meeting the Passivhaus Standard may indicate an E-1. In another example, a property meeting the NAHB Green Standard may indicate an E-4. In another embodiment, guidelines may be used to indicate an energy performance metric for a property. Various guidelines, such as, but not limited to, Living Building Challenge, Architecture 2030 goals, Builders Challenge, LEED Homes, Energy Star v. 3, Enterprise Green Communities, or the like.

In one embodiment, an energy performance metric, such as an index may be used to value a property before and after an energy reduction measure. In one example, a property may be rated as an E-5 before an energy reduction measure. After an energy reduction measure, a property may be rated as an E-3. An approximate difference in a property value, based on a difference in an energy performance metric, may be based on a current value of one or more energy reduction measures.

In another embodiment, other metrics may be used to indicate an energy efficiency of a property, or a structure on a property. For example, a construction index may be used to indicate a quality of construction. For example, an indicator such as Q1 may indicate a very high quality and efficient construction, while a Q6 may indicate poor construction, low efficiency, or the like. Indicators between Q1 and Q6, such as, Q2, Q3, Q4, Q5, or the like, may indicate intermediate construction quality values. In another example, a condition of a property may be represented via an index. Similarly, indicators, such as C1, C2, C3, C4, C5, and C6 may be used to indicate a condition of a property. In one example, C1 may indicate that the property is in like-new condition. In another example, a C6 may indicate that a property is in need of significant repairs and may be very energy inefficient. Other like indicators may be used to indicate other conditions. Various indicators, previously described, may also be considered in determining an energy performance metric for a structure, or similar.

In one embodiment, a trader of energy credits may use an energy performance metric to calculate an aggregated value of energy credits. In one example, a financial entity that finances an energy reduction measure may use associated energy credits as reserves, loan loss, loan payments, balance reductions, loan forgiveness, loan guarantees, or the like.

Traditionally, associated energy credits for energy reduction measures are held by utility companies, however, after reading this disclosure, a financial entity, such as a mortgager, may also use associated energy credits. This may allow a financial entity, to monetize similar energy credits, which may allow greater access to the energy market for property owners. Different governments may require different energy portfolio standards for utility companies. Because utility companies may be required to reduce consumption of energy, there is less motivation for a property owner to engage in an energy reduction measure. Allowing a property owner, or an associated financial entity to take advantage of various energy credits provides more benefit for a property owner to engage in an energy reduction measure. In one example, a financial market may pass through incentives to property owners.

In one embodiment, where a property may generate more energy than it consumes, a utility company may be able to receive excess energy as previously described. This may also allow greater access to green energy sources by a utility company. An owner of the property may receive compensation for this excess energy and may use the compensation to cover costs of the energy reduction measure. In one embodiment, a valuation module may be configured to incorporate the energy performance metric into a financial transaction. For example, a reduction in utility costs associated with an energy reduction measure may be applied to a repayment schedule for a loan.

In one embodiment, the periodic value may be used to calculate a present value for the property. Historical utility costs may be compared with predicted utility costs after an energy reduction measure. For example, monthly energy costs before an energy reduction measure may be compared with monthly energy after an energy reduction measure. For example, a difference in utility costs for each month may be calculated by subtracting the monthly utility costs before the energy reduction measure from the monthly utility costs after the energy reduction measure.

In one embodiment, periodic savings may be aggregated over a life of a loan, the loan for financing the energy reduction measure. For example, with a 20 year loan and a utility energy savings of approximately $50 per month, a present value of the energy reduction measure may be $50 for each of the 240 months, resulting in an approximately current value of $12,000. Therefore, the energy reduction in this example, may increase the value of the property by approximately $12,000. In other embodiment, inflation, depreciation, fluctuations in energy market prices, or other financial analysis may affect the value of the periodic savings. Of course, one skilled in the art may recognize other factors that may affect the value and this disclosure is means to include all such factors.

In one embodiment, a ratio of a cost of an energy reduction measure with a return based on an energy reduction measure may be calculated. Such a ratio may indicate a return on investment for the energy reduction measure. In another embodiment, a yield per square foot may be compared with a cost per square foot. For example, a cost of an energy reduction measure may be divided by a square footage of a structure on a property. Additionally, a yield may be calculated based on a current value of an energy reduction measure. For example, an energy reduction measure may cost $50,000, and may result in an immediate yield of $30,000 based on a current value of the energy reduction measure, as previously described.

In another embodiment, actual energy usage or energy consumption of a property may be measured or monitored after the energy reduction measure. In one embodiment, an energy reduction measure may result in a greater reduction in energy consumption than predicted. A repayment schedule for a loan may be modified based on a difference between an expected utility savings, and a measured utility savings. In one example, utility savings beyond a predicted value may be added to a periodic payment for a loan for the energy reduction measure.

In one embodiment, a periodic audit or analysis of the utility usage or consumption for a property may be performed. A periodic payment for a loan for an energy reduction measure may be modified based on results of the periodic audit. For example, a yearly utility audit may be performed. In another embodiment, regular analysis using a variety of utility monitoring devices may result in an updated periodic payment value. The periodic payment value may change each period depending on energy consumption of the property.

This disclosure sets forth building blocks to enable a new universal currency based on resource lending. While the focus of this disclosure may be directed to green and renewable energy modifications to a building or structure, it is to be understood that the same principles, apparatuses, and methods can be applied in any industry. In one example the property may include an automobile and the energy reduction measure may include installation of a hybrid system, electric energy, hydrogen, or to be developed automobile transit technologies, or the like. Furthermore, lenders can benefit from tax credits, carbon credits, and other incentives. One way of benefiting lenders, such as large financial institutions, is by quantifying regional trading capacity. Alternatively or additionally, the automobile industry could reap some of the benefits of energy reduction measures available through application of the principles described herein. A study of this disclosure will reveal the building blocks for gaining access to as many incentives as are available for energy conserving and renewable energy producing ventures, and in reality this disclosure provides the building blocks for a universal currency for trading these incentive based assets.

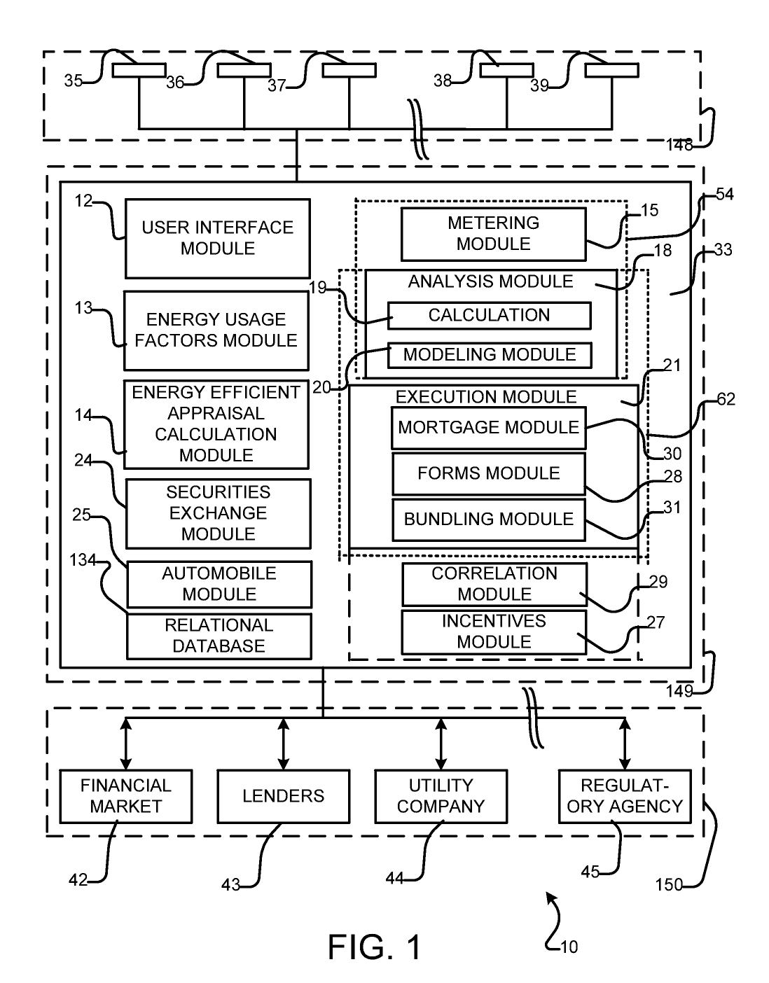

FIG. 1 is a block diagram of an energy quantification system (referred to herein as EQS or system) 10 for determining a savings, (which may be an effectual savings), and applying the savings to a financial transaction in accordance with embodiments of the present invention. The system 10 may include machine-readable code such as software having one or more modules associated with a variety of functions. For example, the code may include a user interface module 12, energy usage factors module 13, energy efficient appraisal calculation module 14, metering module 15, analysis module 18 optionally including calculation and modeling modules 19, 20, and execution module 21. Additional modules may include a securities exchange module 24 and an incentives module 27. Each of the modules may further have submodules. For example, the execution module 21 may include a mortgage module 30. The incentives module may be, or may include, a tax incentive(s) module. The machine-readable code may be stored in memory and incorporated into a computer 33 such as a Web server or other electronic device that includes a processor. It is to be understood that the several modules and components may be in a single electronic device or may be incorporated into a plurality of devices or computers that are interconnected to provide the intended function of the system 10.

In order to determine a savings the system 10 determines a usage of energy for any and all of a plurality of utilities. The system 10 may further include a plurality of detectors 35, 36, 37, 38, 39 that are configured to be associated with a plurality of utilities. For example, detector 35 may be a meter that detects a flow of natural gas to a residential or commercial building and transmits a signal representing the flow of gas to the computer 33 or other electronic device. Detector 36 may be a sensor that detects electrical power usage in the residential or commercial building. Detector 37 may include a meter for determining a flow of water to the building and sending a signal representing the flow to the computer 33. Detector 38 may include a sensor or other metering device indicating a flow, mass, or volume of sewage generated by the building. Detector 39 may be a sensor that detects and signals a quantity of trash in terms of mass or volume. Other detectors may be incorporated without limitation. For example, detectors that measure one or more of electrical current, electrical voltage, and temperature may be utilized. The temperature sensors may be utilized to obtain data for determining a threshold or baseline value with which current energy usage values are compared. The computer 33 or other electronic device may be operably connected to one or more of a plurality of entities that are either interested in the data collected by the computer 33, or from which entities the computer 33 is capable of receiving data. For example, the computer 33 may be connected to one or more entities in financial markets 42, lenders (such as mortgage companies or banks) 43, utility companies 44, and regulatory agencies 45.

Quantification by prediction may be achieved by accessing databases including data from historical data from utility companies, data collected from measuring usage for similar buildings, heating and cooling systems, appliances, occupancy patterns, occupant behavior patterns, or the like.

Thus, the database may be created with data sets from manufactures and measurements in buildings having similar energy usage factors. As such, the database may include the relational database 134 and data collected from actual use to create baselines for specific buildings having particular energy usage factors. The baselines will vary from one region or climate to another. It is to be understood that the financial markets may include existing or future commodities trading institutions. Thus, carbon credits or other commodities may be bought and/or sold through the system.

It is to be understood that certification of carbon credits may require an audit by an authorized independent party. This disclosure may enable such authorized independent auditors to issue certificates to parties of interest through the system 10. Once an energy reduction measure (such as a green construction project) has passed its audit, the auditor can electronically submit the certificate to the party of interest through the system. Thus, the system may verify when carbon or other credits have been certified.

The metering module 15 of the machine-readable code may be configured to receive signals from the detectors 35, 36, 37, 38, 39 and quantify the actual usage of the various utilities that is being detected. Alternatively, the actual usage of the various utilities may be determined all or in part by obtaining the usage from another source such as a utility company, through modeling and/or mathematical formulas, or other, or the like. The system and apparatuses of embodiments of the present invention are capable of utilizing usage data from other sources or signals representing usage from sensors provided independently of the system and apparatuses of the present invention. The analysis module 18 may utilize historic data and/or engineering modeling data to determine a baseline of usage for one or more of the utilities. This may be achieved by execution of baseline formulas that may have been developed to accurately represent the energy usage.

In one example, the current temperature and historic weather patterns may be used to calculate a baseline value of energy usage. Then the analysis module 18 may determine actual utility savings by comparing actual usage to baseline values. This may be accomplished by simply taking the difference between the actual usage and the baseline values. In one form the savings may be represented in terms of energy reduction (ER), baseline energy usage (BEU), and actual energy usage (AEU) and an equation relating these terms.

ER=BEU−AEU Equation 1

Where part of the value is provided by carbon credits, incentives from utility companies and governments, etc., the savings may be an effectual savings represented in terms including these additions to the value of the savings. These may amount to part of the quantification of energy savings. For example, energy reduction value (ERV) may take into account ER, as described above. ERV for each commodity saved may also take into account carbon reduction (CR) and renewable energy credit (RE). The monetary savings may be represented by taking into the price per unit of each of these factors (EP), (CP), (RP) at a particular point in time, as indicated in general equation 2.

ERV=Σ[(ER×EP)+(CR+CP)+(RE×RP)] Equation 2

Other more complex analyses may be undertaken to take into account additional factors. For example, in most cases, the cost of the improvements may be subtracted from the energy savings. The savings minus costs can then be amortized over the life of the improvements at the current interest rate to take into account the time value of the money saved. Alternatively, the lender may re-amortize the loan after taking into account the saving (minus the costs) that may be applied to early repayment. In one embodiment, specific formulas may be developed for calculating the energy efficiency on all utilities. In any case, the metering module 15 and the analysis module 18 may quantify usage and savings, and make these values available in a form that may be understandable and useful to one or more users including the various interested entities 42, 43, 44, 45 through a user interface module 12. In this regard, the machine-readable code of embodiments of the present invention may be configured to interact with conventional computer programs and machine-readable code in computers utilized by these various interested entities. Thus, information derived from formulas and through analysis is translated into a form usable by financial and real estate markets.

In one embodiment, the analysis module utilizes any of a variety of mathematical formulas to calculate the baseline value and the savings. The mathematical formulas may incorporate numerous variables that are supplied from among data that includes one or more of geographical regions, weather patterns, temperatures, and building usage times and patterns. The building usage patterns may include occupancy times, heating and cooling requirements, etc. Theoretically, the more variables that are used in this calculation, the more accurate will be the resulting quantification. On the other hand, it is to be understood that some variables will be less significant or negligible relative to others.

The execution module 21 may utilize data, including data from the analysis module, and any user input to apply at least a portion of the savings to one or more financial transactions. For the purposes of this disclosure financial transactions include one or more of quantification and/or valuation of savings into dollars or other monetary units, prepayment of a loan, purchase of a commodity, request for an incentive credit, initiation of application for a tax credit, etc. In the embodiments shown in FIG. 1, the execution module 21 may include a mortgage module 30 for controlling early repayment of a mortgage loan based on utility savings. It is to be understood that the mortgage module 30 could be separate from the execution module 21 and still function together with the execution module 21 to implement repayment of the mortgage loan. Although shown separately, the securities exchange module 24, the incentives module 27, and/or other modules could be incorporated into the execution module 21.

In particular, the machine-readable code on computer 33 or other electronic device may be configured to interface with mortgage companies or other lenders for the purpose of transmitting quantified data representing energy usage, credits earned, incentives qualified for, and/or energy produced. Additionally or alternatively, the computer 33 or other electronic device may interface to transmit quantified saving data including energy savings and/or other utility savings so that the mortgage companies can apply at least a portion of the savings to early repayment of mortgagee's loans. The machine-readable code may also be configured to automatically and regularly remit a predetermined portion of the savings as an early repayment of the loan or reductions in interest on the loan.

The machine-readable code is configured to interact with a utility company 44, for example, to receive historic and/or current data on a usage of a utility. The historic data may be used by the analysis module 18 to compare the historic data to current usage data and to determine the utility savings. Alternatively or additionally, the machine-readable code may be configured to supply data to the utility company 44 for comparison with their records of usage and/or for sending data indicating a quantity of energy put back into the grid by the building when the building is an energy producing structure.

The machine-readable code may include the securities exchange module 24 that is configured to interact with companies in the financial market 42 for the purpose of purchasing securities or for selling carbon credits, for example. Thus, data representing the purchase or sale values of at least a portion of the utility savings may be transmitted by the securities exchange module 24 to the financial market 42. Similarly, data representing market values of the securities or carbon credits may be transmitted from the financial market to the computer 33 or other electronic device.

The machine-readable code may also be configured to interact with one or more regulatory agencies for the purpose of receiving data or other information regarding interest rates, tax incentives, and/or carbon credits, for example.

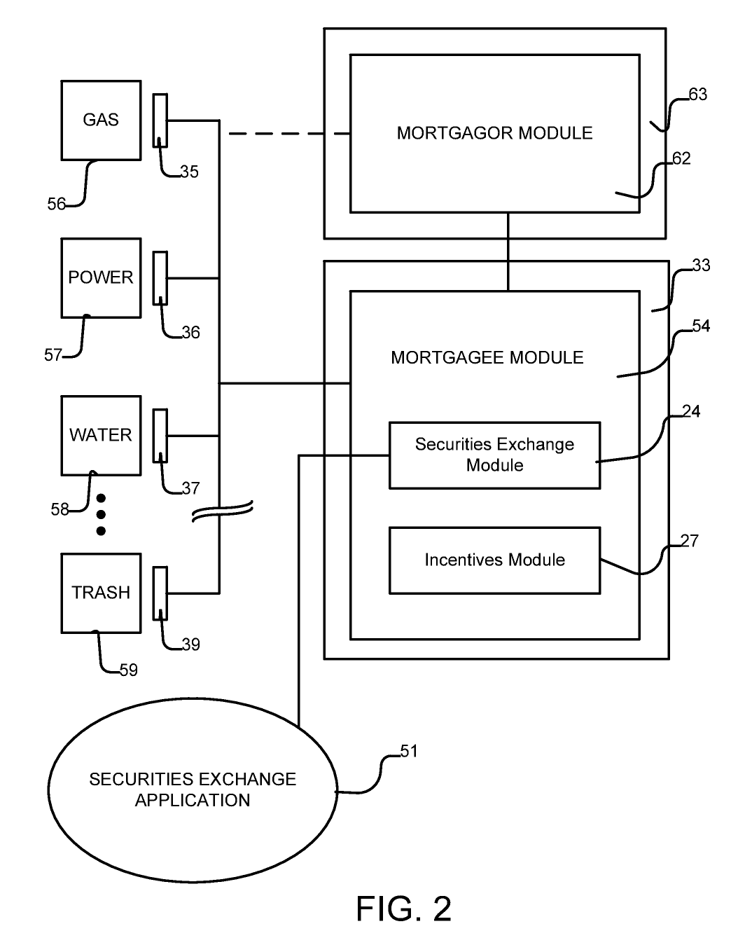

As shown in the specifics of FIG. 2, the apparatus for determining energy usage, determining a related savings of a utility, and applying at least a portion of the savings to a financial transaction may further include the securities exchange or trading module 24 that is configured to interface with the execution module 21 (shown in FIG. 1) and a securities exchange application 51 that may be available in the financial market 42 for automatically applying at least a portion of the savings to investment in a securities exchange market. The securities exchange application 51 may be one of several applications belonging to respective trading institutions throughout the country and/or around the world. As such, the securities exchange module 24 is configured to interface with a variety of applications and is capable of sending and receiving data in a compatible or converted form. In this way, the execution module 21 can interface with the security exchange institutions to buy and sell carbon credits, renewable energy credits (RECs), and/or other incentives of value. Alternatively, the securities exchange application 51 may be integrated as a non-remote module in the apparatus, and may receive regular or frequent updates to data from the financial market.

An automobile module 25 may also be included for analyzing savings and credits associated with green features on automobiles, such as, but not limited to, fossil fuel carbon reductions, associated costs, energy savings reductions, or the like.

The automobiles may have green features that are provided by the original manufacturer or that are retrofitted to the vehicles, such as, but not limited to, hybrid systems, alternative fuel systems, or the like. As with real estate property improvements, values of green features on automobiles may be quantified, bundled, and/or applied to transactions for individuals or companies. Automobile manufacturers may benefit from bundled values of carbon credits or other credits that may be traded or sold.

FIG. 2 also shows how the securities exchange module 24 and the incentives module 27 may form part of a mortgagee module 54. It is to be understood that the mortgagee module 54 may include all of the modules and submodules shown in FIG. 1. Alternatively, the mortgagee module 54 (represented by the dashed line labeled 54 in FIG. 1) may include at least a portion of at least one of the analysis module 18 and the metering module 15. The mortgagee module 54 may be supported on a computer 33 or other electronic device located at the mortgagee's building, for example. Thus, the detectors 35, 36, 37, 39 may be directly associated with respective utilities such as gas 56, power 57, water 58, and trash 59, for example. That is, sensors, meters, and/or other detectors may be placed on gas, power, and water lines or meters as needed. The detectors 35, 36, 37, and 39 are operatively connected to the computer 33 or other electronic device in order to transmit signals representing usage of the various utilities. It is to be understood that the connection between the computer 33 or other electronic device and the detectors or other devices may be wired or wireless connections.

While the machine-readable code providing the various modules shown in FIG. 1 may be configured to interface with conventional computer programs and code utilized by interested entities 42, 43, 44, and 45, these interested entities may alternatively have respective modules loaded on their computers for interfacing with the various modules shown in FIG. 1. Thus, FIG. 2 shows a mortgagor module 62, which may be supported on a computer 63 located at one of the lenders corresponding to lenders 43 in FIG. 1. It may not be required that the modules shown in FIGS. 1 and 2 be located at the user's or mortgagee's building. In fact, in one embodiment, the modules shown in FIG. 1 may be incorporated into the mortgagor module 62 of FIG. 2. In this case, the mortgagee module 54 may not need the securities exchange module 24 and the incentives module 27 because they may be included in the mortgagor module 62. Signals representing the utilities usage could be transmitted by a wired or wireless connection from the user or mortgagee's building to the mortgagor module 62 at the mortgage company. While the mortgage company may have a direct interest in applying the utility savings to early payment of a mortgage loan, the machine-readable code and modules on the computer 63 at the mortgage company may still implement investment in securities and initiation of incentive credit and/or tax credit requests for the mortgagee. In one example, a borrower may assign his/her tax credits directly to a lender and may borrow full value, assigned value. This may allow a borrower to acquire equipment with little to now initial capital outlay on the investment.

Alternatively, these credits could be received by the mortgagor or developer in exchange for improved loan terms to the mortgagee. In an alternative embodiment, a dashed line labeled 62 in FIG. 1 may show the mortgagor module 62 including at least a portion of at least one of the analysis module 18 and the execution module 21.

It is to be understood that the number and type of utilities monitored to quantify usage, and the utility savings to be quantified in accordance with the embodiments of the present invention is unlimited. While FIGS. 1 and 2 show gas, power, water, sewer, and trash, other utilities may be monitored for savings as well. For example, other fuels such as heating oil, coal, alcohol, hydrogen, fuel cells, diesel fuel, and other forms of energy previously described may be additionally or alternatively monitored and/or quantified. Still, the metering and analysis modules determine usages of the plurality of utilities and compare the usages, reduction, savings, or the like, with predetermined baseline values of the respective utilities to quantify savings.

While the various modules have been described as providing a system and apparatus for integrating a utility baseline for valuation of a property, it is to be understood that such a system and apparatus may include as few as one of the modules described, or may include more than the number of modules shown and described. In any case, the system an apparatuses described herein may be used to implement embodiments of the method of the present invention described below.

The schematic flow diagrams that follow are generally set forth as logical flow diagrams. As such, the depicted order and labeled steps are indicative of embodiments of the presented method shown in respective figures. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

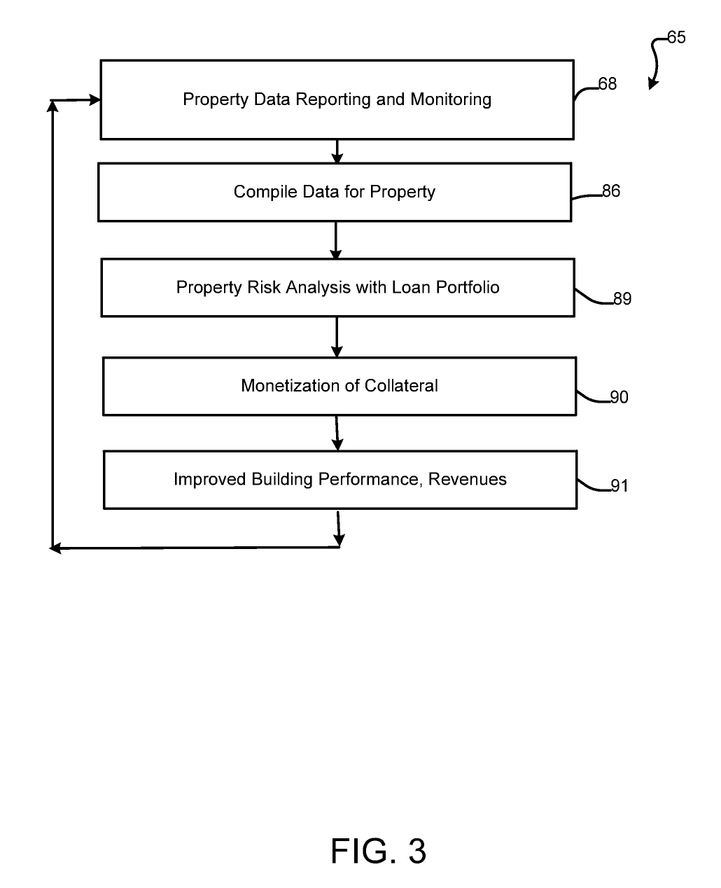

FIG. 3 is a flow chart view illustrating one embodiment 65 of a method for integrating a utility baseline for property valuation. The method 65 begins with a determination module monitoring 68 utility data for a property. The determination module may compile 86 data for the property. The determination module may analyze 89 risk associated with a property for a loan portfolio. A valuation module may monetize collateral associated with the property, or associated with an energy reduction measure. A valuation module may measure 91 improved building performance, revenues, property valuation of improved valuations, or the like. The method may continue at block 68.

As described one embodiment, the method may continue through the described blocks (68, 86, 89, 90, 91). As properties are improved in a given area, property data reporting and monitoring may become more accurate. Furthermore, real-time data may be aggregated and included in projected predicted baseline calculations. This may also improve utility baselines and/or value for neighborhoods or other geographic areas because as the method is applied to multiple properties, utility baselines for a neighborhood may begin to include energy efficiency of the various properties in the neighborhood. Over iterations, properties in a geographic region that have included an energy reduction measure, or the like, may be used to compare to a property in a market analysis. In one example, a market analysis may incorporate energy efficiency, energy performance metrics, or the like, in an appraisal value. This appraisal value, based on comparable properties that include energy reduction measures, further enhances the appraisal system, and provides better method for valuation of properties that include an energy reduction measure.

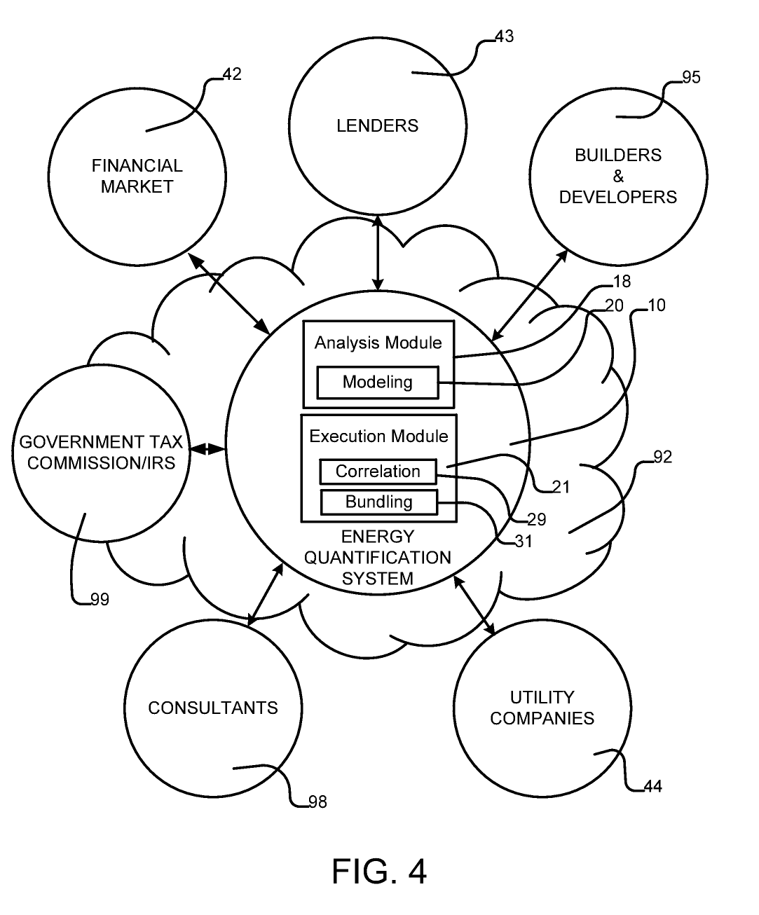

FIG. 4 is a diagrammatic view illustrating how the system 10, in accordance with embodiments of the present invention, may be interconnected with a variety of entities that may be interested in participating in the programs and methods associated with the system. Indeed, the system 10 and related methods may be made available universally to interested entities. For example, data and instructions may be communicated over a network 92 such as the Internet, a local area network, a wide area network, the Internet, a cloud based network, another network, a telephone network, or other, or the like. The network 92 may include wired and wireless connections. As shown in FIG. 4, whether the system 10 is located at a location of the mortgagee, mortgagor, some other location, or at a combination of locations, the system 10 can be operably connected over the network 92 to a variety of interested entities including entities in the financial markets 42, lenders 43, renewable energy companies, and utility companies 44. Other interested entities may include builders and developers 95, consultants 98, and government agencies 99 such as tax commissions and/or the Internal Revenue Service (IRS), or other property tax authorities.

As described above, the EQS 10 may include an analysis module 18 for calculating energy usage/energy savings, and an execution module for applying the savings to a financial transaction. The analysis module 18 may include a modeling module 20 for modeling the savings/incentives to users. The system 10 also includes the execution module 21, as discussed above. As shown in FIGS. 1 and 4, the execution module 21 may include a correlation module 29 for correlating all the available green incentives, assigned incentives, identified incentives, assets, or the like, with each of the green construction projects. The execution module may also have a bundling module 31 to facilitate modeling of the savings/incentives to users and for bundling savings/incentives in attractive and concrete ways. In other ways, high-performance lending and incentivized ways may benefit consumer building and/or owner/investor markets.

In certain examples, n some embodiments, the correlation module 29 and the bundling module 31 may not form part of the execution module 21. In any case, these modules make the payback mechanisms clear and viable for the financial market 42, lenders 43, consumers, building owners for cost effective incentivized methods and/or benefits. For example, if a financial institution can have numerous incentives automatically quantified and bundled to have a definite value through the system 10, then the financial institution may readily use the system 10 to identify the effectual savings, consider improved rates for loans, and/or otherwise pass incentivized savings along to consumers, developers, and others. Thus, the EQS 10 may form a bridge or nexus platform between the builders and developers 95 on one hand and the financial market 42 and the lenders 43 on the other hand with regard to green, high-performance or sustainable energy construction projects. The systems and methods are presented with a high degree of visibility and transparency resulting in positive public relations for all types of users of the system 10, and economic benefits for continuing in or entering the emerging green/sustainable energy markets.

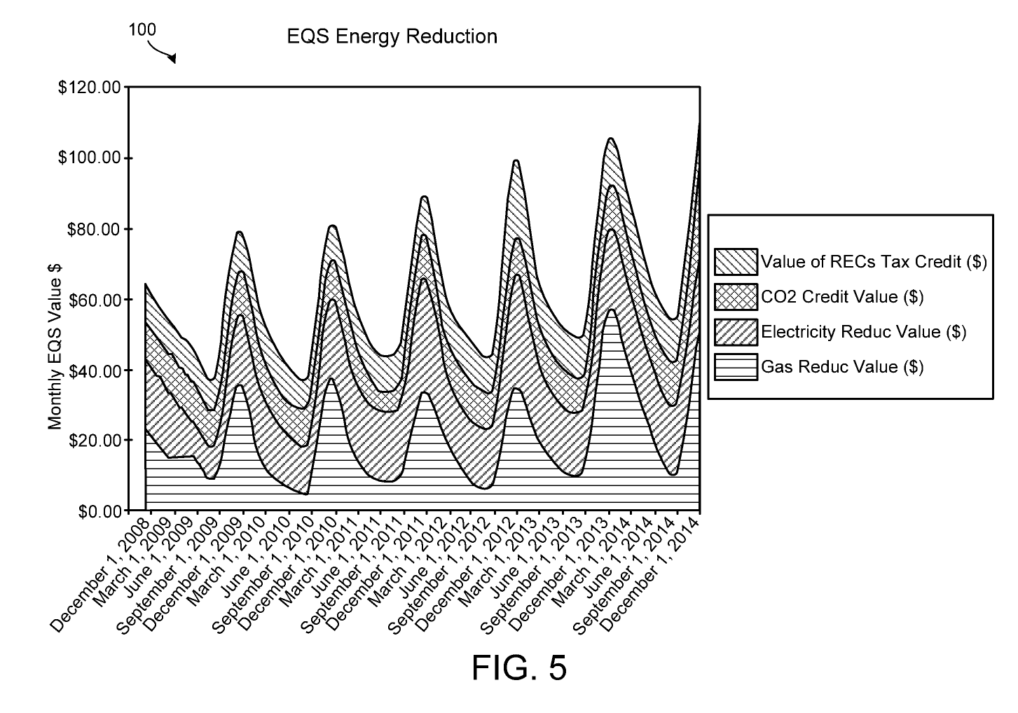

For example, referring back to Equation 2, a visual illustration in the form of a graph 100 shown in FIG. 5 makes clear the energy reduction value (ERV) for a particular building or retrofit project. As shown, there is more overall energy saved during the winter months even though more electricity is used and saved during the summer for the particular building and in the climate selected. In warmer climates savings may be spread through the year. The dollar value of the savings is indicated by the curve of the graph as compared with the amounts shown on the left hand side of the graph 100. Thus, the energy savings becomes clear to the user, and he/she can readily understand an average savings that may offset capital outlay and/or investments that will be available to be applied to repayment of a loan or another financial transaction such as application of the savings to purchase a tradable commodity.

The system 10 and methods in accordance with embodiments of the present invention may also bring together resources and benefits from the financial sector, well-established Internet based platforms and entities, renewable energy policy makers, and energy raters. In one embodiment, resources and benefits may be made available together in a single site on an Internet website. In exchange for the benefits of using these resources from a single place and the other advantages of the systems and methods describe herein, users may be required to pay fees. These fees may include one or more of membership fees, licensing fees, royalty fees, and product override fees/marketing fees for green/sustainable products. An example of a benefit that users will most likely be willingly to pay for through these fees is the creation of baselines for the green financial models. These baselines may be needed by the financial and real estate markets for more universal entry into the green/sustainable building markets. Fees for using the energy quantification databases, which may include these baselines, may also be charged. Owners of Internet-based applications supporting the systems and methods may charge fees for the development and maintenance of the applications. These fees may be passed through to users in addition to directly associated fees such as mortgage loan fees to help cover business costs, loan transaction costs, or other, or the like.

In one embodiment, the system 10 includes machine-readable code supported on a server remote from the mortgagee and the mortgagor. In this embodiment, consultants 98 may use the system 10 to help builders and developers 95 to benefit from utility savings programs. In accordance with this embodiment, individuals or corporations wishing to conserve energy or to become energy producers in their building projects can access the needed information and become participants in the utility savings programs including programs that are set up to help mortgagees pay off their mortgages early. In this regard the system 10 may be supported on a platform that is universally available. For example, the platform may be a Web-based platform, cloud based platform, or the like. Such a platform may be developed from scratch or the method may be implemented on existing platforms that are already well known and universally accessible. In any case, the system 10 and method 65 may be platform independent.

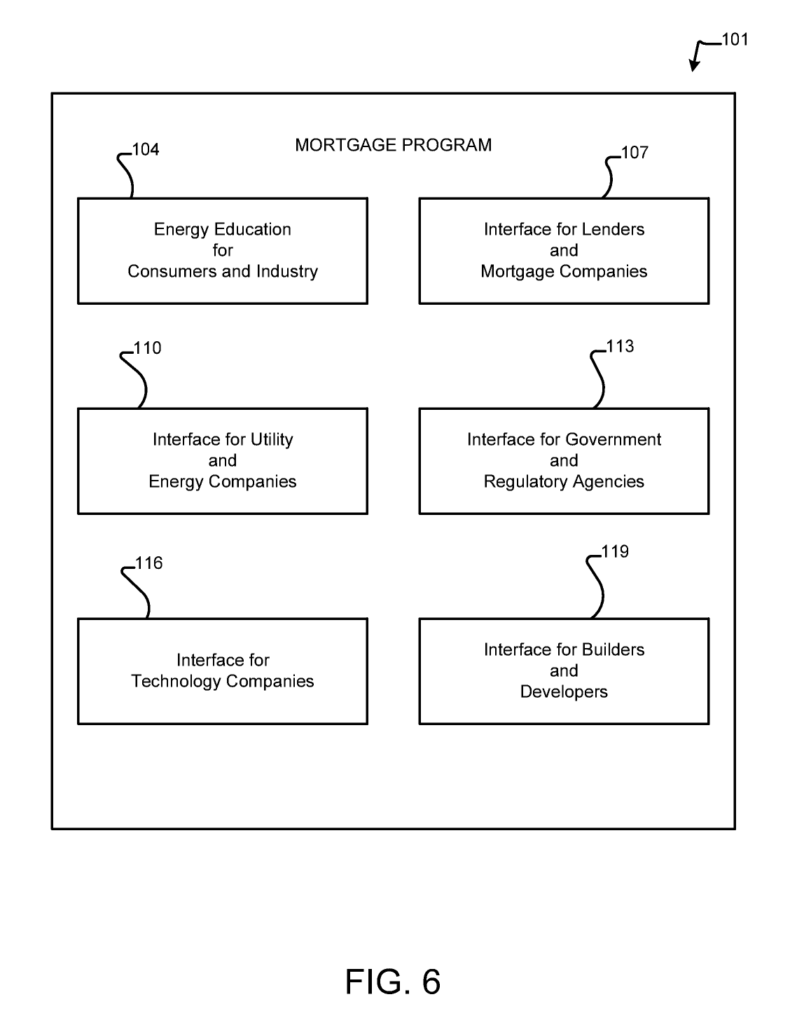

FIG. 6 is a diagrammatic view of an example of at least a portion of a program 101 that is available to interested entities. In this example, the program 101 is a mortgage program. Such a mortgage program may be embodied in a mortgage module 30 as shown in FIG. 1. As described above, the mortgage module 30 may be located at the mortgagor or the mortgagee, or may be located at a separate location such as on a server on the Internet. The mortgage program may include energy education for consumers and the industry 104. In addition to benefiting the public as an educational tool, the energy education and its presentation through the systems and methods described herein also facilitate marketing of green/sustainable energy technologies, including the systems and methods described herein. The mortgage program 101 may also include several interfaces that are provided by respective submodules for communication and/or data transfer to and from interested entities. These entities may include lenders and mortgage companies as indicated at 107, utility and energy companies as indicated at 110, and government and regulatory agencies as indicated at 113, such as, but not limited to, banks, private investment portfolios, credit unions, REIT's pension funds, insurance funds, and/or other financial market vehicles as described herein, or other, or the like.

Other interested entities may include technology companies, builders, and developers, as indicated at 116 and 119. The machine-readable code and/or other digital processing mechanisms that at least in part make up the mortgage program 101 may be configured to be compatible with conventional software that is typically used by the various interested entities. Additionally or alternatively, compatible software may be provided, such as by a download, to each interested entity. Thus, data can be transferred and transactions can be executed without difficulty.

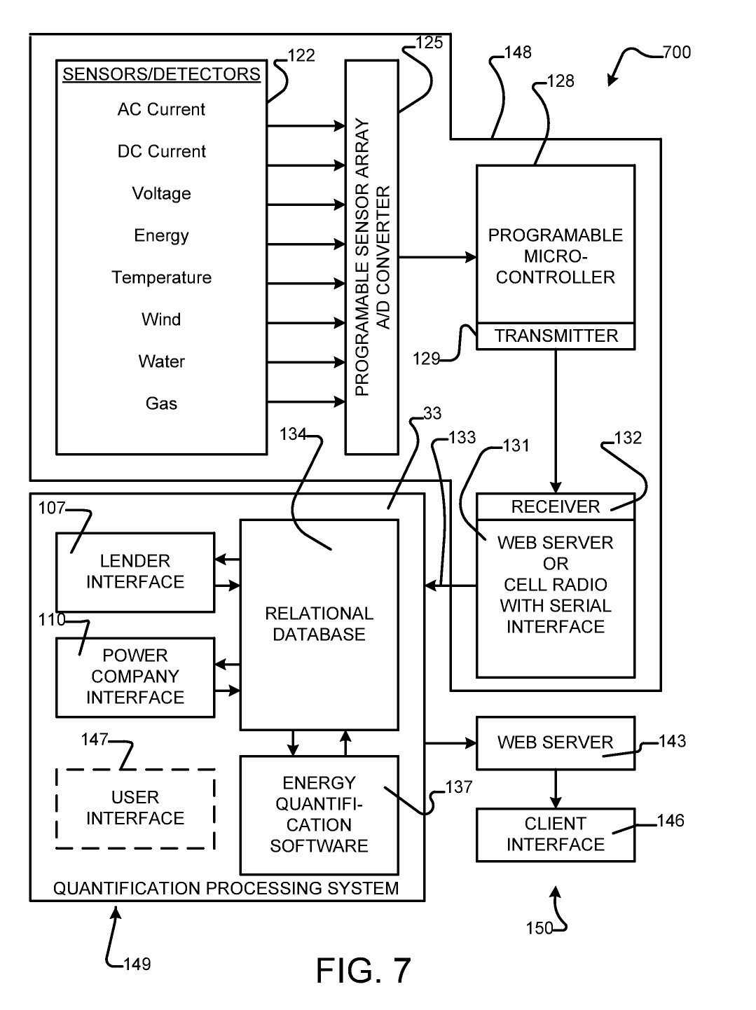

FIG. 7 is a block diagram illustrating a system for integrating a utility baseline for property valuation in accordance with embodiments of the present invention. In one embodiment, the system 700 may include a plurality of sensors or detectors 122 that sense, detect, monitor, measure, or the like, energy consumption. The detectors 122 may connect with a programmable sensor array 125 that may monitor, compare, restricts, energy usage, or the like. The sensor array 125 may communicate with a programmable microcontroller 128 as one skilled in the art may appreciate. The microcontroller may include a transmitter 129 that may transmit measured energy usage to a receiver 132. The receiver 132 may communicate with a web server 131, or the like. The server 131 may upload received data to an energy quantification system (EQS) 149.

The EQS 149, in certain embodiments, may include a database 134 for storing received data, executable code 137 for processing the data, and various interfaces for users of the EQS 149, such as, but not limited to, a lender interface 107, a power company interface 110, and a user interface 147. Of course, one skilled in the art may recognize other interfaces and this disclosure is not limited in this regard.

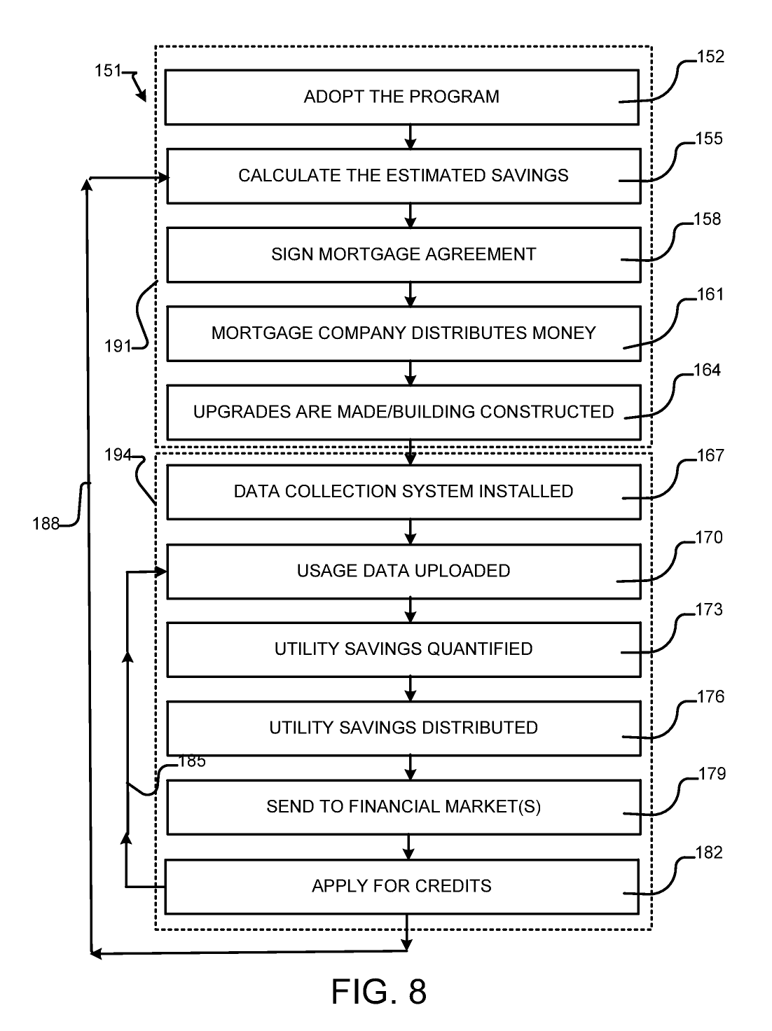

FIG. 8 is a flow chart diagram illustrating one example of a method 151 in accordance with one embodiment of the present invention. In one embodiment, the method 151 may begin and a module may adopt 152 the EQS program. A module may calculate 155 estimated savings based on one or more energy reduction measures. A module may authenticate 158 or electronically sign in response to an indication from a user. A module may receive 161 funds from a mortgage company. One or more energy reduction projects may be performed 164 on the property. A data collection system may be installed 167 on the property. Energy data usage may be uploaded 170 to a remote server or database 134. Utility savings may be quantified 173. Savings may be distributed 176 to interested parties. The savings may be distributed 179 to one or more financial markets. Credits may be applied 182 and the method may continue at block 155.

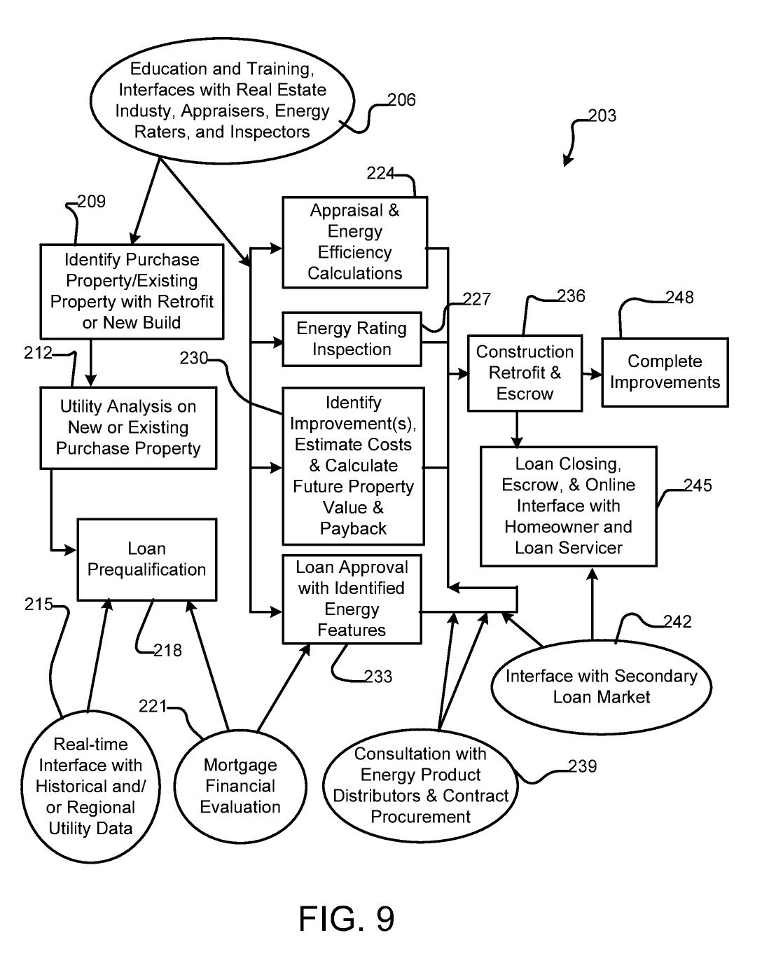

FIG. 9 is a diagram illustrating one example of a method 203 for property valuation including energy usage. In one embodiment, the method 203 may begin and a module may educate 206, train, instruct, or otherwise disseminate information regarding the method to interested parties. A module may receive 209 one or more potential purchase properties. A module may perform 212 a utility analysis on one of the properties. A module may submit prequalification papers for a loan to finance an energy reduction measure. A financial entity may evaluate 221 the prequalification papers. A module may analyze 215 real-time energy usage for the property. A module may perform 224 energy usage calculations. A module may request 227 an energy rating inspection. A module may identify 230 one or more energy reduction measures. A module may approve 233 the loan. A module may indicate to construct 236, and may be notified 248 when construction of the energy reduction measure is completed. A module may close 245 the loan and/or may interface 242 with a secondary or privatized loan market.

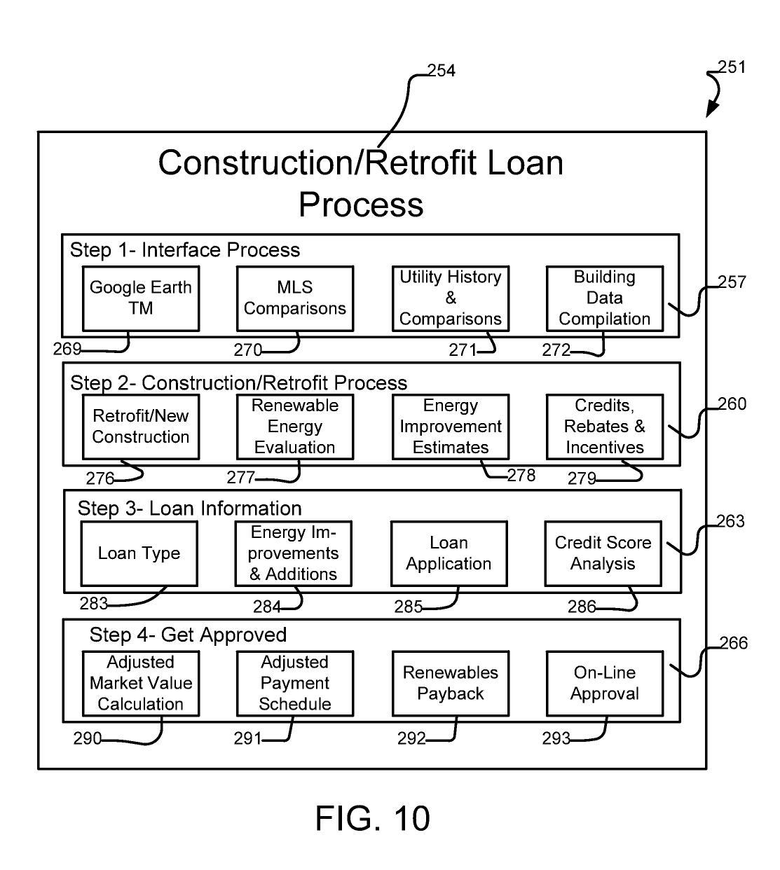

FIG. 10 is a flow chart diagram illustrating one embodiment of a method for property valuation including energy usage. In one embodiment, the method 251 may begin and a module may interface 257 with one or more data warehouses 269,270, 271,272. A module may indicate to perform 260 one or more energy reduction measures. A module may provide 263 loan information, such as, but not limited to, a loan type 283, an energy reduction measure associated with the loan 284, a loan application 285, a credit score 286, or other, or the like. A module may approve 266 the loan and may provide an adjusted calculation 290, an adjusted payment schedule 291, a renewable payback 292, and/or an approval, 293, or other, or the like, and the method may end.

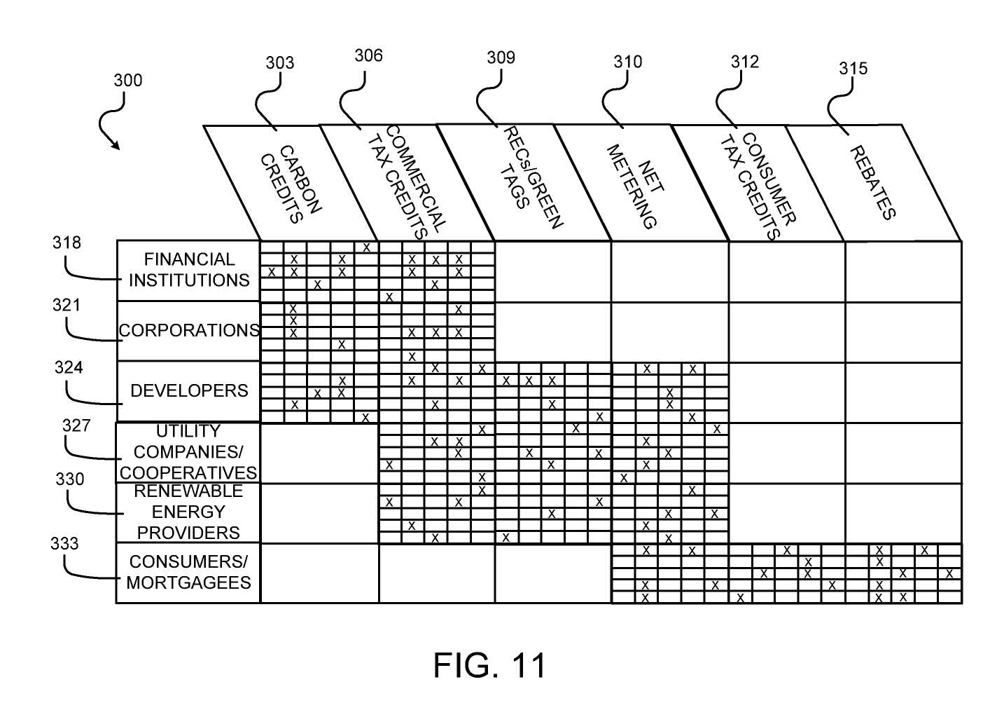

FIG. 11 is an example chart depicting one example according an embodiment of the present invention. As depicted, a module may generate a chart 300 may associate interested parties 318,321,324,327,330,333 with types of compensation or interest in the property. Such a chart may help facilitate mapping between interested parties and available compensation. Of course, one skilled in the art may recognize other types of charts and this disclosure is not limited in this regard.

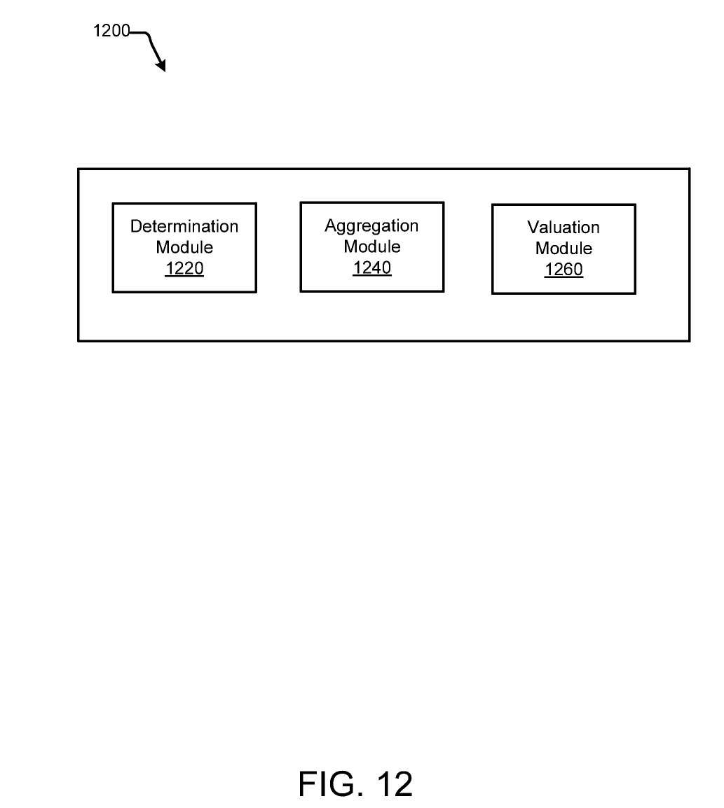

FIG. 12 is a diagram illustrating one embodiment of an apparatus in accordance with the present invention. According to one embodiment 1200, an apparatus may include a determination module, 1220, an aggregation module 1240, and a valuation module 1260.

The determination module may predict energy usage for a property for a period of time. The aggregation module 1140 may perform any of the aggregation methods described herein. The determining module may determine a value for the property based on energy usage savings as described herein.

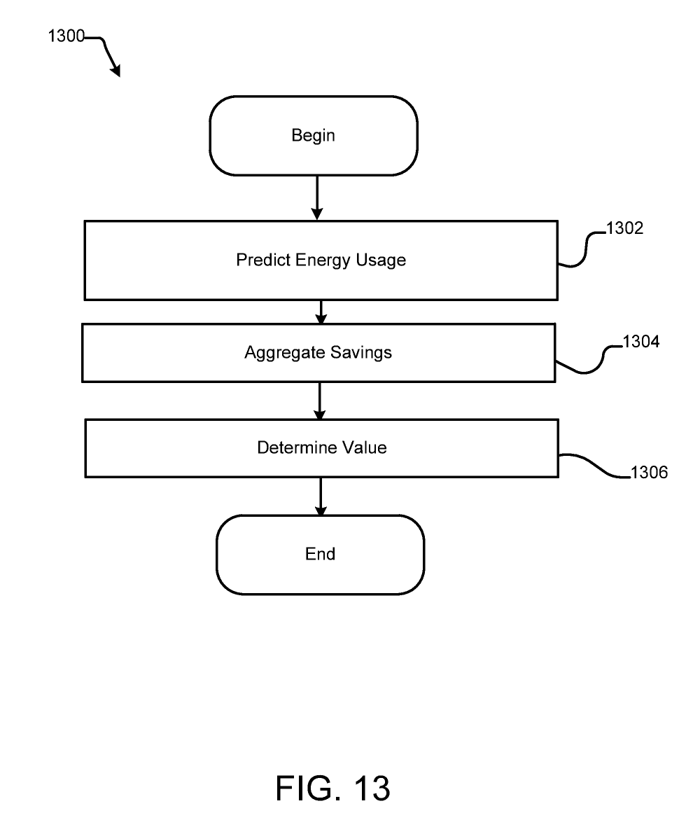

FIG. 13 is a flow chart diagram illustrating one embodiment of a method in accordance with one embodiment of the present invention. In one embodiment 1300, the method may begin and a module may predict 1302 energy usage for a property for a period of time. The energy usage may be any of the forms of energy described herein, or others. A module may aggregate 1304 savings based on completion of an energy reduction measure. A module may determine 1306 a value for the property as described herein. The value for the property may include a periodic value for payments of a loan that financed the energy reduction measure or may be a current value of the property upon completion of the energy reduction measure and the method may end.

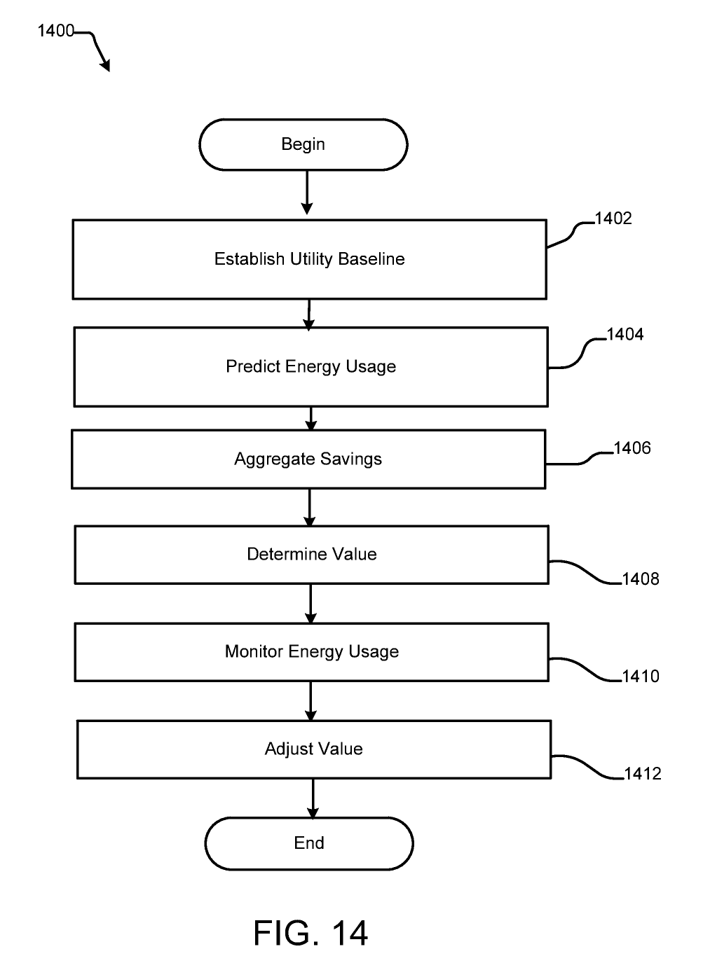

FIG. 14 is a flow chart diagram illustrating one embodiment of a method in accordance with one embodiment of the present invention. In one embodiment 1400, a module may establish 1402 a utility baseline. A module may predict 1404 energy usage. A module may aggregate 1406 savings over a period of time. A module may determine 1408 a value as described herein. A module may monitor 1410 energy usage for a property. A module may adjust 1412 the value based on the monitored energy usage. In one example, where predicted energy consumption was less than actual energy consumption, a module may decrease the value of the property, or may increase the value of one or more payments to repay a loan for the energy reduction measure and the method may end.

The present invention may be embodied in other specific forms without departing from its spirit or essential characteristics. In fact, the embodiments or portions thereof may be combined in any way. The described embodiments are to be considered in all respects only as illustrative and not restrictive. The scope of embodiments of the invention is, therefore, indicated by the appended claims rather than by the foregoing description. All changes which come within the meaning and range of equivalency of the claims are to be embraced within their scope.

What is claimed is:

1. A method comprising:
predicting energy usage for a property for a period of time;
aggregating a predicted energy usage reduction based on a project that decreases the energy usage for the property; and
determining a value adjusted for the aggregated energy usage reductions.

2. The method of claim 1, wherein the value is selected from the group consisting of a value of energy credits earned by the property, a periodic value for payments for a loan for the property, and a value of the property.

3. The method of claim 1, further comprising establishing a utility baseline for the property, the predicting based on the utility baseline.

4. The method of claim 3, wherein the utility baseline is based on one of historical energy usage for a similar property and an energy audit for the property.

5. The method of claim 1, the aggregating further based on a plurality of projects that decreases the energy usage for the property.

6. The method of claim 1, further comprising monitoring energy usage after the project is completed and adjusting the value based on the monitored energy usage.

7. The method of claim 1, wherein the energy usage comprises a municipal utility.

8. An apparatus comprising:
a determination module that predicts an energy usage of a property for a period of time;
an aggregation module that aggregates a predicted energy usage reduction based on a project that decreases the energy usage for the property; and
a valuation module that determines a value adjusted for the aggregated energy usage reduction,
wherein at least a portion of the determination module, the aggregation module, and the valuation module comprise one or more of hardware and executable code, the executable code stored on one or more computer readable storage media.

9. The apparatus of claim 8, wherein the value is selected from the group consisting of energy credits earned by the property, payments for a loan for the property, and a value of the property.

10. The apparatus of claim 8, further comprising a calculation module that establishes a utility baseline for the property, the determination module predicts based on the utility baseline.

11. The apparatus of claim 10, wherein the utility baseline is based on one of historical energy usage for a similar property and an energy audit for the property.

12. The apparatus of claim 8, wherein the aggregation module aggregates based on a plurality of projects that decreases the energy usage for the property.

13. The apparatus of claim 8, further comprising a determination module that monitors energy usage after the project is completed and adjusts the value based on the monitored energy usage.

14. The apparatus of claim 8, wherein the energy usage comprises a governmental utility.

15. A computer program product comprising a computer readable storage medium having program code embodied therein, the program code readable/executable by a processor for:
predicting energy usage for a property for a period of time;
aggregating a predicted energy usage reduction based on a project that decreases the energy usage for the property; and
determining a value adjusted for the aggregated energy usage reductions.

16. The computer program product of claim 15, wherein the value is selected from the group consisting of energy credits earned by the property, payments for a loan for the property, and a value of the property.

17. The computer program product of claim 15, the code further comprising instructions for establishing a utility baseline for the property, the predicting based on the utility baseline.

18. The computer program product of claim 17, wherein the utility baseline is based on one of historical energy usage for a similar property and an energy audit for the property.

19. The computer program product of claim 15, the aggregating further based on a plurality of projects that decreases the energy usage for the property.

20. The method of claim 1, further comprising monitoring energy usage after the project is completed and adjusting the value based on the monitored energy usage.
